(19) United States
(12) Patent Application Publication
(10) Pub. No.: US 2004/0172355 A1
(43) Pub. Date: Sep. 2, 2004

(54) Option valuation method and apparatus

(76) Inventor: Gurupdesh S. Pandher, Chicago, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/770,984

(22) Filed: Feb. 3, 2004

Related U.S. Application Data
(60) Provisional application No. 60/445,099, filed on Feb. 6, 2003.

(51) Int. Cl. G06F 17/60

(52) U.S. Cl. 705/37

(57) ABSTRACT

Empirical data for a given option is processed using regression modeling to provide one or more option valuation models for the option. That model (or models) is then used to value the option with respect to future worth. When multiple different models are provided, resultant data can be developed from each model. That resultant data is then compared against historical data for the option to identify a particular one of the models that appears most accurate. That most-accurate model is then used to value the option with respect to future worth.

I claim the benefit of Provisional Patent Application No. 60/445,099, entitled “Valuation of Options and Derivative Securities with Localized Option Regression (LOR) Models” and as filed on Feb. 6, 2003.

### TECHNICAL FIELD

This invention relates generally to the valuation of options with respect to future worth.

### BACKGROUND

Options of various kinds are known in the art, including but not limited to options that pertain to a right to obtain shares of a publicly traded (or privately held) stock or bond, to mine or to drill, to purchase currencies or commodities, to future contracts, to forward contracts, and so forth. In general, an option typically comprises a legal right that permits the holder to exercise a specified transaction by or before a given date upon a given set of terms and conditions notwithstanding changing circumstances that may otherwise arise and that may impact the then-present value of that future transaction. The future worth of a given option can depend upon numerous unpredictable events and conditions and hence cannot usually be known for a certainty. Nevertheless, for various reasons, it is often important to be able to assess a likely future worth of an option.

Those skilled in the art are familiar with so-called risk-neutral approaches to value a future worth of an option. A risk-neutral approach to option valuation is based on the central idea of hedging the price risk of the derivative security by dynamically trading in the underlying tradable asset. Then, to rule out arbitrage, the hedged position must earn the return of the risk-free asset. The well-known benchmark Black-Scholes approach (and others) employ these dynamic-hedging and no-arbitrage arguments to derive a partial differential equation and to solve it to obtain closed-form option valuation formulas.

Although considerable research effort has been put towards extending the initial Black-Scholes framework by relaxing certain assumptions and incorporating additional features in the asset return process (including jumps, mean-reversion, stochastic volatility, and so forth), relatively less progress has been reported in the development of non-structural methods for modeling and estimating market option prices.

### BRIEF DESCRIPTION OF THE DRAWINGS

The above needs are at least partially met through provision of the option valuation method and apparatus described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention;

FIG. 4 comprises a graph depicting predicted daily implied volatilities;

FIG. 5 comprises a graph depicting out-of-sample pricing errors as plotted by moneyness;

FIG. 6 comprises a graph depicting daily average pricing errors as based on out-of-sample predictions; and

FIG. 7 comprises a graph depicting predicted values based on price-smile regressions.

Skilled artisans will appreciate that elements in the figures are illustrated for simplicity and clarity. Common but well-understood elements that are useful or necessary in a commercially feasible embodiment are often not depicted in order to facilitate a less obstructed view of these various embodiments of the present invention. It will also be understood that the terms and expressions used herein shall have the meaning ordinarily ascribed to such terms and expressions in the relevant field and art except where a more specific definition is provided herein.

### DETAILED DESCRIPTION

The proposed methodology presents an econometric approach to modeling and valuing options based, at least in part, on localized option regression (LOR) modeling that does not impose assumptions regarding the underlying asset dynamics, volatility structure, or hedging behaviors typically required by the risk-neutral approaches of the prior art.

Generally speaking, pursuant to these various embodiments, empirical data for an option of interest if provided. That empirical data is then processed using regression modeling to provide an option valuation model for the option. This option valuation model can then be used to value the option with respect to future worth. Such an approach comprises an econometric approach to modeling and options are preferably valued based on localized option regression modeling where market option prices are projected over localized regions of their state process up to maturity. In a preferred embodiment, no assumptions regarding the underlying asset dynamics, volatility structure, or hedging behavior are required and the localized option regression approach offers an alternative, fast, and robust data-driven method for valuing option books without distributional assumptions such as log-normality.

Empirical studies provide evidence that this localized option regression approach yields smaller average pricing errors than a commonly used efficient Black-Scholes implementation and further improves upon the so-called volatility smile. Comparison with other studies using the same sample further demonstrates that the disclosed approaches are competitive with more sophisticated extensions involving stochastic volatility and jumps in the asset return price. This localized option regression modeling approach also offers an efficient and robust econometric benchmark for evaluating the performance of more complex structural risk-neutral models.

These teachings are particularly apt for use with computational platforms of choice (including both central and distributed processing facilities).

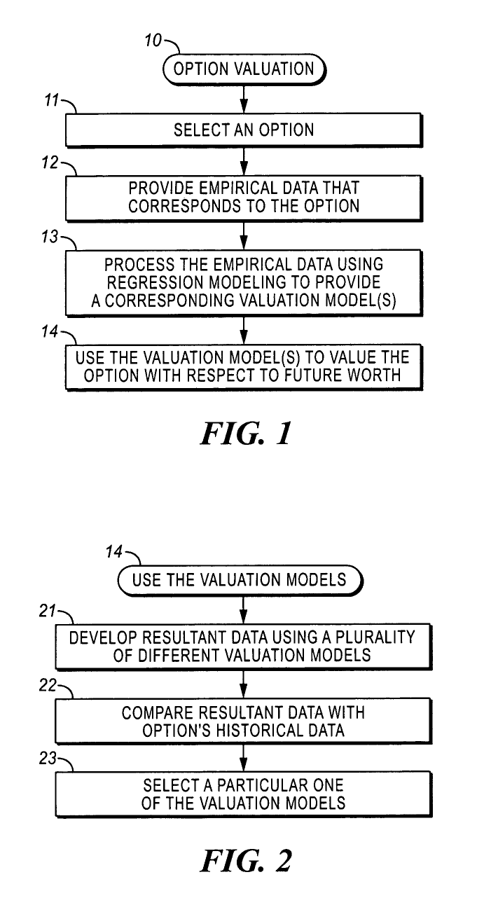

Referring now to the drawings, and in particular to FIG. 1, pursuant to these various embodiments, an option valuation process 10 provides for selection 11 of a given option. Virtually any option will suffice. Examples include, but are not limited to, index options, interest rate options, currency options, bond options, stock options, and commodity options to name a few (such options are well understood in the art and therefore additional description regarding such options will not be provided here). The option selected will typically be an option of interest to the user. In particular, the user will usually wish to develop an estimation of future worth for the option (the user may be interested in this estimation with respect to the projected maturity of the option or as to some earlier point in time).

The option valuation process 10 then seeks the provision 12 of empirical data that corresponds to the selected option. Such empirical data can comprise, for example, but need not be limited to pricing information (such as all daily prices, daily closing prices, a daily median price, daily opening prices, and so forth) that corresponds to the option. In general, such empirical information will preferably be provided as corresponds to a substantially immediately preceding window of time (typically but not necessarily having at least a predetermined duration) but can correspond to other windows of time as appropriate and/or as available. For example, the empirical data can represent daily closing prices (or all daily prices) for a preceding window of time comprising at least fifty days. Longer or shorter durations can of course be utilized (perhaps to better suit the proclivities of a given option, option market, or other conditions of note).

Such empirical data can be gathered in various ways. For example, the data can be gathered and stored in an automatic fashion in real-time (or near real-time) as the data-generating events of interest occur. As another example, the empirical data of interest can be gathered retroactive to the occurrence of the data-generating events (by accessing and mining public or private databases, reports, information reserves, and the like).

The option valuation process 10 then processes 13 the empirical data using regression modeling to provide a corresponding valuation model (or models as the case may be). Pursuant to one approach, this process can include projecting market option prices over localized regions of the option's state process (for example, up to a date or event of interest, such as projected maturity of the option). Pursuant to one approach, this process can include modeling the option's non-linear behavior around a corresponding strike price (or other price or event of relevance or interest). As to the latter, a moneyness variable (or variables) can be used to facilitate such modeling (in finance, moneyness is typically viewed as a measure of the degree to which a derivative security is likely to have positive monetary value at its expiration). Pursuant to yet another approach this process can include provision of a reduced-form option valuation model (and can further take into account, if desired, implied volatility of the option). (Additional details regarding such approaches are set forth below.)

The option valuation process 10 then uses 14 the valuation model (or models) to value the selected option with respect to future worth. In a preferred approach, this comprises localizing estimation of option regressions to sub-regions of overall state space as corresponds to the option. This can include, when desired or appropriate, sequentially estimating option regressions as a function, at least in part, of maturity-moneyness clusters over a rolling estimation window.

As noted above, the option valuation process 10 can support the provision of multiple valuation models and subsequent use of such a resultant plurality of models. With reference to FIG. 2, when multiple valuation models are available for use 14, resultant data can be developed 21 using a plurality of different valuation models. This may include use of all available models or some selected subset as appropriate to the needs of a given application. The resultant data is then compared 22 with historical data that corresponds to the option. In a preferred approach, the resultant data for each processed valuation model will be compared against a common set of historical data regarding the option (for example, the resultant data will each be compared and contrasted against daily market closing option prices in the sample). These comparisons are then used to select 23 a particular one of the valuation models to be used, for example, to value the option with respect to future worth.

So configured, a plurality of regression-based option valuation models are developed using empirical data for the option and then tested against actual historical performance of the option to identify a particular one of the plurality of LOR option valuation models that appears to most closely track the actual historical behavior of the option. That particular option valuation model can then be used to predict future worth of the option.

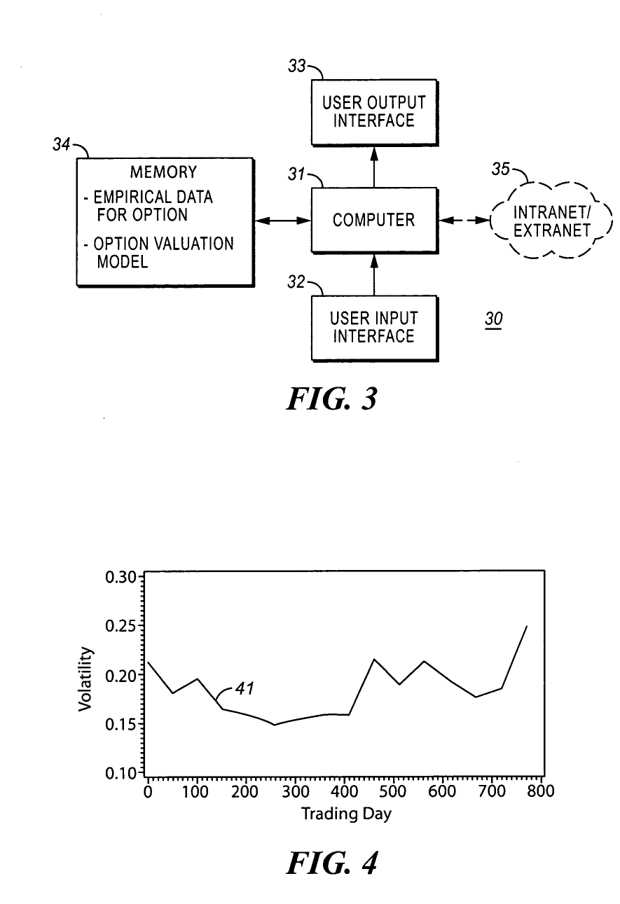

Such processes can be embodied in a variety of ways as will be well understood by those skilled in the art. Pursuant to a preferred approach, such a process will be partially or fully implemented as a set of computational instructions. With reference to FIG. 3, for example, a supporting system 30 can comprise a computer 31 having a user input interface 32 (such as a keyboard and cursor control mechanism) and a user output interface 33 (such as a display or printer) can further have (or couple to) a memory (or memories) 34 that include the empirical data and option valuation model (or models) described above.

It will be understood by those skilled in the art that various architectural configurations are available to support such functionality and capability. For example, multiple computational platforms can be utilized to parse and/or otherwise distribute the overall empirical analysis and valuation process over such multiple platforms. Such a distributed approach may be particularly appropriate when the computer 31 operably couples to a network 35 comprising, for example, an intranet or an extranet (such as the Internet) that provides ready access to other computational platforms. So configured, one or more computational platforms can serve as empirical data servers, regression analysis servers, option valuation servers, and so forth. Such servers can then receive (or provide) relevant variable information for a requesting client to facilitate these processes in a more distributed fashion.

More specific embodiments will now be described. At least four useful structural and reduced-form option valuation regression models are set forth herein (with such models being illustrative of these concepts and not comprising an exhaustive listing or presentation). These serve as basic models for the localized option regression (LOR) modeling described below where these option valuation regressions are sequentially localized to maturity-moneyness regions of the options' state space.

Let V represent the value of a given market-traded option with underlying asset price S (e.g. index, stock, currency, bond), time of option expiration T, strike price K, volatility σ, and the risk-free rate r being represented as respectively indicated. Further, with t representing any time up to expiration, then τ=T−t is the option's time to maturity.

A preferred approach considers two classes of localized option regressions structural and reduced-form models—that represent derivative prices as localized projections on its state process based on the underlying asset price, exercise strike price, time-to-maturity, and the risk-free rate. The state space includes linear, quadratic, and interaction terms arising among the state variables. The structural specification attempts to explicitly model the options' non-linear behavior around the strike price through the moneyness variable m=S/K. In contrast, the reduced-form model incorporates this interaction in a more flexible and unstructured fashion.

The first two models are based on projecting market options onto a linear and quadratic state-space of the state variables (S,τ,K,r). The remaining two models further include the options' implied volatility σ_{IV}, as an additional predictor.

Reduced-form Model (RLOR):

V=α₀+α₁S+α₂K+α₃τ+α₄r+α₅S²+α₆K²+α₇τ²+α₈r²+α₉SK+α₁₀Sτ+α₁₁Sr+α₁₂Kτ+α₁₃Kr+α₁₄τr+ε (1)

Structural Model (SLOR):

V=α₀+α₁m+α₂K+α₃τ+α₄r+α₅m²+α₆K²+α₇τ²+α₈r²+α₉mK+α₁₀mτ+α₁₁mr+α₁₂Kτ+60 ₁₃Kr+α₁₄τr+ε (2)

Reduced-form Volatility Model (RLOR-V):

$$\begin{matrix}V = {α}_{0} + {α}_{1} S + {α}_{2} K + {α}_{3} τ + {α}_{4} r + {α}_{5} {S}^{2} + {α}_{6} {K}^{2} + {α}_{7} {τ}^{2} + \\ {α}_{8} {r}^{2} + {α}_{9} SK + {α}_{10} S τ + {α}_{11} Sr + {α}_{12} K τ + {α}_{13} Kr + {α}_{14} τ r + \\ {α}_{15} {σ}_{IV} + {α}_{16} {σ}_{IV}^{2} + {α}_{17} {σ}_{IV} S + {α}_{18} {σ}_{IV} K + {α}_{19} {σ}_{IV} τ + \\ {α}_{20} {σ}_{IV} r + ϵ\end{matrix} \qquad ( 3 )$$

Structural Volatility Model (SLOR-V):

$$\begin{matrix}V = {α}_{0} + {α}_{1} m + {α}_{2} K + {α}_{3} τ + {α}_{4} r + {α}_{5} {m}^{2} + {α}_{6} {K}^{2} + {α}_{7} {τ}^{2} + \\ {α}_{8} {r}^{2} + {α}_{9} mK + {α}_{10} m τ + {α}_{11} mr + {α}_{12} K τ + {α}_{13} Kr + {α}_{14} τ r + \\ {α}_{15} {σ}_{IV} + {α}_{16} {σ}_{IV}^{2} + {α}_{17} {σ}_{IV} m + {α}_{18} {σ}_{IV} K + {α}_{19} {σ}_{IV} τ + \\ {α}_{20} {σ}_{IV} r + ϵ\end{matrix} \qquad ( 4 )$$

The complete models presented above can be considered as shown. In an empirical implementation, however, multi-collinearity and statistical insignificance of some coefficients can be leveraged to reduce corresponding model size (respective estimates are reported in Table III presented below). By letting Z represent the generic (row) vector of explanatory variables in equations 1-4, then the above option regressions may be generically expressed as:

V=Zα+ε (5)

where α is the parameter vector. For example in the RLOR case:

Z=(S,K,τ,r,S²,K²τ²,r²,SK,Sτ,Sr,Kτ,Kr,τr)¹

α=(α₀,α₁,α₂,α₃,α₄,α₅,α₆,α₇,α₈,α₉,α₁₀,α₁₁,α₁₂,α₁₃,α₁₄).

For the volatility LOR models represented by equations 3 and 4, a mechanism for estimating implied volatility over the strike-maturity space is also useful for at least some applications. This can be accommodated by adopting implied volatility modeling as is further discussed in below.

In the above option regressions (1)-(5), the derivative price process is represented as a projection of market option prices on the complete state process. The empirical results show that localizing estimation of the option regressions to sub-regions of the state space unlocks a great deal of efficiency and leads to large reductions in pricing errors. This makes the LOR method at least competitive with Black-Scholes valuation.

In localized option regression modeling, and pursuant to a preferred though not required process, one sequentially estimates the option regressions of equations 1 through 4 by maturity-moneyness clusters over a rolling estimation window. This approach reflects a natural application where LOR is estimated sequentially using recent market data and used to price new options as predicted values. There is some flexibility in the determination of the estimation window (cycle) and localization clusters and some empirical investigation may be helpful in a given instance to identify a best delineation by balancing the tradeoff between model fit and sample size. For instance, while increased localization improves the fit of the option regression, it may also reduce the sample size for estimating model parameters in each cluster. Since here primary interest focuses on the potential of LOR as a valuation tool, these teachings focus on its out-of-sample performance in determining the length of the estimation cycle and the localization clusters.

For an empirical study, there are two identified moneyness groups (based on values of the moneyness parameter m=S/K) and three maturity groups as reported in Table I presented below. A moving window of 50 days is used leading to a total of 22 estimation cycles denoted by q=1, . . . ,22. The moneyness categories are m ∈ [0.9,1] and m ∈ [1,1.1] and the time-to-maturity groupings are defined as τ ∈ [7,50], τ ∈ [50,100], and τ>100. (Interestingly, greater localization does not necessarily decrease the over-all pricing error. For example, in this instance these two moneyness groupings provide better performance than refinement to four groupings separated by intervals of 5%.) Finally, let c represent a maturity-moneyness cluster formed by a particular combination of the maturity and moneyness groups listed in Table I (e.g. c=(τ ∈ [50,100], m ∈ [0.9,1])).

TABLE I
Maturity-Moneyness Clusters used in LOR Modeling
The maturity-moneyness clusters used in estimating the localized
option regression (LOR) models are based on six combinations of the
following groups. The moneyness parameter is defined by m = S/K.

| Moneyness | Option Maturity Groups |
|---|---|
| Groups | (Days) |
| m ε [0.9,1] | [7,50] |
| m ε (1.1.1] | (50,100] |
| | >100 |

Localization of the option regressions presented in equations 1 through 4 to sequential maturity-moneyness clusters is represented generically as

V(q,c)=Zα(q,c)+ε (6)

where V(q,c) is the market price of an option with state variables Z in estimation period q and maturity-moneyness cluster c and α(q,c) is the parameter vector.

The first step in this particular embodiment (using multiple LOR models) to determine new option prices involves estimating and identifying the best LOR model from the candidates (1)-(4). If either of the volatility models RLOR-V (3) or SLOR-V (4) are selected, then the regressor state space also involves the implied volatility variable σ_{IV} in addition to (S, K, τ, r). In such a case, an estimate of volatility in required. A method for doing this is described next prior to describing the estimation of out-of-sample LOR option prices.

Volatility estimates can be obtained in various ways including by applying known implied volatility regressions. For example, it is known to model the relationship between implied volatility and an option's strike and maturity over recent market prices. One such useful approach is identified as

τ_{IV}=β₀+β₁K+β₂K²+β₃τ+β₄τ²+62 ₅Kτ+ε. (7)

where the option's implied volatility is estimated numerically by inverting the relevant Black-Scholes formula on the market option price:

σ_{IV}=BS⁻¹(S,τ,K,r,σ)

where

BS(S,τ,K,r,σ)=SN(d)−e^{-rτ}N(d−\sqrt{τ}σ) (8)

is the Black-Scholes call option formula with d=(1n(S/K)+(r+σ²/2)τ)/\sqrt{τ}σ.

Let d represent the sample period (e.g. day, week) over which the implied volatility regression will be estimated (note that d is much smaller than the rolling estimation window q used in LOR modeling). Therefore, the parameters of the implied volatility regressions may be represented as

σ_{IV}(d)=β₀(d)+β₁(d)K+β₂(d)K²+β₃(d)τ_{, d∈q,}+β₄(d)τ²+β₅(d)Kτ+ε (9)

for each period d. In accord with well recognized practice, one may select the estimation period d for the volatility regression (9) to be one trading day. The estimated parameters are then used to generate the implied volatility estimates for the LOR models (3)-(4) described above.

To determine out-of-sample option prices, the previous day estimates from (9) will be used to predict next-day implied volatilities. Averages 41 of predicted daily implied volatilities across all option strikes and maturities are graphed by trading day in FIG. 4 for S&P500 call options from June 1988 to May 1991.

To obtain new option prices, LOR parameters may first be estimated from market options prices observed in the previous estimation period q. Then, out-of-sample LOR option values in the subsequent period q+1 (with state variables (S,K,τ,r)) can be generated as follows:

No Volatility Case: If the LOR is model (1) or (2)

In this case, an estimate of volatility is not required. The LOR option value in period q+1 and maturity-moneyness cluster c is then calculated as

V(S,K,τ,r;q+1,c)=Z(S,K,τ,r)α(q,c) (10)

where Z(S,K,τ,r) is the vector of corresponding LOR regressor variables and α(q,c) is the corresponding parameter vector estimated from market options in the previous period q and maturity-moneyness cluster c. Similarly, if the LOR model is (2), the LOR option value is calculated as

V(m,K,τ,r;q+1,c)=Z(m,K,τ,r)α(q,c) (11)

Volatility Case: If LOR is model (3) or (4)

In this case, estimate the next day out-of-sample implied volatility for day d+1 as

σ_{IV}(K,τ;d+1)=β₀(d)+β₁(d)K+β₂(d)K²+β₃(d)τ+β₄(d)τ²+β₅(d)Kτ (12)

where the parameters β(d)=(β₀(d),β₁(d),β₂(d),β₃(d),β₄(d),β₅(d)) are estimated by fitting the volatility regression (9) to implied option volatilities from the previous day d.

The LOR out-of-sample option values in period q+1 and maturity-moneyness cluster c are then calculated as follows:

σ=σ_{IV}(K,τ,d+1), d+1 ∈q+1,

RLOR-V model (3): V(S,K,τ,r,σ;q+1,c)=Z(S,K,τ,r,σ)α(q,c) (13)

SLOR-V model (4): V(m,K,τ,r,σ;q+1,c)=Z(m,K,τ,rσ)α(q,c) (14)

where Z(S,K,τ,r,σ) and Z(m,K,τ,r,σ) are the column vectors of LOR regressors according to (3) and (4), respectively. The corresponding parameters α(q,c) are estimated from options trading in period q and maturity-moneyness cluster c.

In order to directly evaluate the in-sample and out-of-sample performance of LOR, one can use a known Black-Scholes implementation as a benchmark model (here the so-called “Practitioner Black-Scholes” or PBS model has been so used). A critical issue for obtaining Black-Scholes option prices is how to infer volatility across the spectrum of exercise prices and maturities. Prior art practitioners typically identify the best implied volatility regression as

σ_{IV}=β₀+β₁K+β₂K²+β₃τ+β₄τ²+β₅Kτ+ε. (15)

Volatility regression parameters for (15) estimated from recently observed market option prices are then used to construct volatility estimates for out-of-sample Black-Scholes option prices.

As in the case of LOR volatility estimation (9), one can apply such volatility modeling to daily options and use the estimated parameters to predict next-day implied volatility by strike price and maturity. For any give day d in the sample, the volatility parameters are estimated from the regression

σ_{IV}(d)=β₀(d)+β₁(d)K+β₂(d)K²+β₃(d)τ+β₄(d)τ²+β₅(d)Kτ+ε (16)

With q representing the current LOR estimation period, the corresponding PBS option value with state variables (S,K,τ,r) in the subsequent period q+1 is obtained as follows:

i) Estimate the out-of-sample implied volatility for day d+1 as

σ_{IV}(K,τ;d+1)=β₀(d)+β₁(d)K+β₂(d)K²+β₃(d)τ+β₄(d)τ²+β₅(d)Kτ (17)

where the parameters β(d)=(β₀(d),β₁(d),β₂(d),β₃(d)τ,β₄(d),τ₅(d)) are estimated by fitting the volatility regression (9) to implied option volatilities from the previous period d.

ii) Calculate the Black-Scholes option values for day d+1 as

σ=σ_{IV}(K,τ;d+1)

PBS(S,τ,K,r,σ;q+1)=(S−PVD)N(d₁)−e^{-rτ}N(d−\sqrt{τ}σ) (18)

where d₁=(1n(S/K)+(r+σ²/2)τ)/\sqrt{τ}σ and S−PVD is the S&P500 index net of the present value of dividends. Note that (18) refers to the European Black-Scholes (BS) formula and would be replaced with the appropriate BS formula, and its extensions, for other types of options (e.g. Puts).

To assess the quality of the fitted models and their pricing performance, the following metrics are used:

i) Adjusted R-squares from estimated option regressions and LOR models.

ii) The average pricing error (PE) or the root mean square error (RMSE) of model prices. This is the square root of the average squared deviations between actual market option prices and model prices. These are tabulated for both the LOR and PBS models across various groupings defined by time-periods (overall, year, quarter, cycle) and maturity-moneyness categories.

iii) The coefficient of variation (CV) gives the average pricing error as a percentage of mean call price. It is constructed by dividing the RMSE from ii) by the mean call price corresponding to the grouping (multiplied by 100).

The efficiency gain (EFF) is the percentage reduction in pricing error of LOR over the PBS benchmark. It is calculated as one minus the ratio of the RMSE of LOR to the RMSE of PBS times 100.

The empirical analysis presented herein uses option prices on the S&P500 index options as traded on the Chicago Board of Options Exchange (CBOE). Options written on the S&P500 index are the most actively traded European-style contracts. This data was selected due to the high market liquidity of these options and their frequent use in earlier empirical studies. (S&P500 index options have been the focus of many investigations related to the estimation and performance of option pricing models, risk-neutral densities and implied volatility analysis.)

In particular, certain prior art studies use a three year sample of daily call option prices on the S&P500 index from Jun. 1, 1988 to May 31, 1991 to evaluate the performance of alternative option pricing models including Black-Scholes and extensions with stochastic volatility, jumps, and stochastic interest rates or to demonstrate that consistency in the choice of loss functions for estimation and evaluation significantly improves the performance of option models. This exact sample is used herein to evaluate the described LOR option model as it facilitates comparison of pricing errors and the volatility smile across studies. A brief description of this data is provided below for the convenience of the reader.

Table II reports the summary statistics for variables related to daily closing S&P500 call options over the three year sample (for 38,487 options).

TABLE II
Descriptive Statistics

| | | | | | |
|---|---|---|---|---|---|
| Variable | Units | Mean | Std | Min | Median |

Panel A: Descriptive statistics

| | | | | | |
|---|---|---|---|---|---|
| Call Option Price (V) | $ | 24.48 | 21.02 | 0.66 | 18.75 |
| SP500 Index (X) | | 323.22 | 32.34 | 248.71 | 327.83 |
| Exercise Price (K) | | 316.82 | 40.02 | 175.00 | 320.00 |
| Risk-free Rate (r) | | 0.0772 | 0.0100 | 0.0252 | 0.0795 |
| Time-to-maturity (τ) | Days | 115 | 86 | 7 | 95 |
| Volatility (σ) | | 0.2073 | 0.0684 | 0.0819 | 0.1917 |

| Variable | Units | Max | Kurtosis | Skew |
|---|---|---|---|---|
| Call Option Price (V) | $ | 100.00 | 1.033 | 1.205 |
| SP500 Index (X) | | 389.59 | −0.799 | −0.319 |
| Exercise Price (K) | | 425.00 | −0.540 | −0.074 |
| Risk-free Rate (r) | | 0.1009 | 0.550 | −0.731 |
| Time-to-maturity (τ) | Days | 367 | −0.338 | 0.759 |
| Volatility (σ) | | 0.8914 | 14.091 | 2.834 |

| | |
|---|---|
| Moneyness | Days-to-Maturity (days) |

| | | | | | |
|---|---|---|---|---|---|
| (m = S/K) | [7, 50] | (50, 100] | (100, 150] | (150, 200] | >200 |

Panel B: Average call prices by Moneyness-Maturity categories

| | | | | | |
|---|---|---|---|---|---|
| <0.85 | | | $1.43 | 3.25 | 4.82 |
| (0.85, 0.9] | $0.82 | 1.67 | 3.23 | 5.21 | 8.89 |
| (0.9, 0.95] | $1.52 | 3.12 | 6.79 | 9.77 | 15.40 |
| (0.95, 1.0] | $3.83 | 8.15 | 13.99 | 17.87 | 24.03 |
| (1.0, 1.05] | $12.75 | 18.19 | 24.40 | 28.35 | 34.45 |
| (1.05, 1.1] | $25.29 | 30.39 | 35.34 | 38.68 | 44.87 |
| (1.1, 1.15] | $37.43 | 42.92 | 46.09 | 51.08 | 56.10 |
| >1.15 | $61.75 | 63.08 | 68.79 | 72.13 | 75.91 |

Panel C: Number of options in Moneyness-Maturity combinations

| | | | | | |
|---|---|---|---|---|---|
| <0.85 | 0 | 0 | 46 | 72 | 260 |
| (0.85, 0.9] | 12 | 158 | 475 | 420 | 865 |
| (0.9, 0.95] | 747 | 1,272 | 1,221 | 1,126 | 1,147 |
| (0.95, 1.0] | 3,376 | 1,962 | 1,380 | 1,231 | 1,198 |
| (1.0, 1.05] | 3,275 | 1,650 | 1,146 | 1,045 | 909 |
| (1.05, 1.1] | 2,426 | 1,173 | 910 | 662 | 677 |
| (1.1, 1.15] | 1,078 | 782 | 596 | 337 | 591 |
| >1.15 | 1,072 | 866 | 738 | 483 | 1,103 |

Summary statistics for variables related to closing daily S&P500 call options from Jun. 2, 1988 to May 31, 1991 consisting of 38,487 options. Panel B reports the means by moneyness-maturity categories and Panel C gives the corresponding number of options in each combination.

The intra-day bid-ask quotes for S&P500 call options are obtained from the Berkley Options Database. For the analysis, option prices are formed by taking the average of the last reported bid-ask prices (prior to 3:00 P.M., Central Standard Time) for each day in the sample. This yields a total of 38,487 closing option prices by trading day, strike, and time-to-maturity. The corresponding S&P500 index values are synchronous to the closing option prices and the index series was adjusted for dividend payments. For the risk-free return, data on daily Treasury-bill bid and ask discounts is used with maturities up to one year, as reported in the Wall Street Journal. Following convention, an annualized interest rate was constructed by forming an average of bid-ask Treasury Bill discounts.

The results from fitting the reduced-form and structural option regression models (1)-(4) on the complete sample are reported in Table III. (To remove multi-collinearity problems, some statistically insignificant terms in the complete model were removed.)

TABLE III
Estimation of the Reduced-Form & Structural Option Regressions

| RLOR | | | | RLOR-V | | |
|---|---|---|---|---|---|---|
| N = 38487 | | | | N = 38487 | | |
| Parameter | Estimate | S.E. | p-value | Estimate | S.E. | p-value |

Panel A: Reduced-form Option Regression - without implied
volatility (RLOR) and with implied volatility (RLOR-V)

| Intercept | −79.84047 | 1.58482 | <.0001 | −20.57762 | 1.29347 | <.0001 |
|---|---|---|---|---|---|---|
| S | 1.04889 | 0.00959 | <.0001 | 0.53545 | 0.007960 | <.0001 |
| K | −0.41694 | 0.0066 | <.0001 | −0.47016 | 0.006480 | <.0001 |
| τ | 0.12199 | 0.00201 | <.0001 | −0.007230 | 0.001820 | <.0001 |
| r | −331.01583 | 10.19839 | <.0001 | 102.80166 | 8.19313 | <.0001 |
| S² | 0.00277 | 0.00001754 | <.0001 | 0.003590 | 0.00001409 | <.0001 |
| K² | 0.0034 | 0.00000957 | <.0001 | 0.003470 | 0.00000876 | <.0001 |
| τ² | −0.0001469 | 0.00000132 | <.0001 | −0.00012701 | 0.00000092 | <.0001 |
| SK | −0.00724 | 0.00002028 | <.0001 | −0.007110 | 0.00001724 | <.0001 |
| Sτ | −0.0001292 | 0.00000559 | <.0001 | 0.00020119 | 0.00000438 | <.0001 |
| Sr | 1.74005 | 0.04771 | <.0001 | 0.78183 | 0.03998 | <.0001 |
| Kτ | 0.00015371 | 0.00000399 | <.0001 | 0.00001328 | 0.00000357 | 0.0002 |
| Kr | −1.00151 | 0.04131 | <.0001 | −0.99314 | 0.03740 | <.0001 |
| τr | 0.01635 | 0.013 | 0.2085 | 0.39348 | 0.009740 | <.0001 |
| σ | | | | 48.84034 | 2.29227 | <.0001 |
| σ² | | | | −18.94554 | 0.87780 | <.0001 |
| στ | | | | 0.16482 | 0.002480 | <.0001 |
| σS | | | | −0.23264 | 0.006710 | <.0001 |
| σK | | | | 0.24567 | 0.005970 | <.0001 |
| σr | | | | −98.5760 | 12.04575 | <.0001 |
| R² | 0.9917 | | | 0.9962 | | |
| \sqrt{MSE} | $1.91432 | | | $1.29853 | | |
| SLOR | | | | SLOR-V | | |
| Parameter | Estimate | S.E. | p-value | Estimate | S.E. | p-value |

Panel B: Structural Option Regressions - without implied
volatility (SLOR) and with implied volatility (SLOR-V)

| | | | | | | |
|---|---|---|---|---|---|---|
| Intercept | 61.08867 | 2.58377 | <.0001 | 117.79971 | 2.07702 | <.0001 |
| m | −0.17671 | 0.01 | <.0001 | −0.62653 | 0.007990 | <.0001 |
| K | −209.1852 | 2.49143 | <.0001 | −231.61593 | 2.20305 | <.0001 |
| τ | 0.19747 | 0.00263 | <.0001 | 0.022780 | 0.002330 | <.0001 |
| r | −560.72895 | 17.41768 | <.0001 | −117.15934 | 14.75335 | <.0001 |
| m² | −0.00109 | 0.00001342 | <.0001 | −0.00003114 | .00001183 | 0.0085 |
| K² | 65.95335 | 0.86851 | <.0001 | 101.45768 | 0.90662 | <.0001 |
| τ² | −0.00014274 | 0.00000151 | <.0001 | −0.00012235 | .00000116 | <.0001 |
| mK | 0.82669 | 0.00442 | <.0001 | 0.66122 | 0.004310 | <.0001 |
| mτ | 0.00004625 | 0.0000048 | <.0001 | 0.00026438 | .00000392 | <.0001 |
| mr | 0.79347 | 0.03633 | <.0001 | −0.10808 | 0.02872 | 0.0002 |
| Kτ | −0.079 | 0.00131 | <.0001 | −0.048250 | 0.00135 | <.0001 |
| Kr | 207.8841 | 13.83197 | <.0001 | 186.71978 | 14.14917 | <.0001 |
| τr | 0.00338 | 0.01484 | 0.8200 | 0.38908 | 0.01222 | <.0001 |
| σ | | | | 123.04548 | 3.00817 | <.0001 |
| σ² | | | | −11.20498 | 1.16542 | <.0001 |
| στ | | | | 0.18677 | 0.00312 | <.0001 |
| σm | | | | 0.08025 | 0.00640 | <.0001 |
| σK | | | | −98.12362 | 2.10254 | <.0001 |
| σr | | | | −101.3339 | 15.66606 | <.0001 |
| R² | 0.9891 | | | 0.9940 | | |
| \sqrt{MSE} | $2.19805 | | | $1.63378 | | |

This table reports the estimation of the four reduced-form and structural option regression models (equations 1 through 4) over S&P500 call options in the complete sample from Jun. 1, 1988 to May 31, 1991 of 38,487 options. R-squares, RMSEs, parameter estimates and their standard errors and significance probabilities (p-values) are reported. To avoid multicollinearity, some non-significant terms were removed from the complete specification.

Panels A and B show that the fit of the four models, as implied by their R-squares, is extremely high (falling in the range 0.9873-0.9962). The average pricing errors of the reduced-form models with respect to CBOE market prices (as measured by RMSE) are uniformly lower than their structural counterparts. Pricing errors for the volatility models are $1.299853 and $1.63378 for RLOR-V and SLOR-V, respectively. The same for the novolatility models increase to $1.91432 and $2.19805 for RSLOR and SLOR, respectively.

It appears from the global fit that option regressions with implied volatility as a predictor have a distinct advantage, at least under some conditions. As shown below, this advantage continues to hold when estimation is sequentially localized to maturity-moneyness clusters, although the difference narrows. Lastly, all parameter estimates reported in Table III are highly significant (with most significance probability or “p-values” less than 0.0001).

For purposes of illustration and comparison, the proposed localized option regression (LOR) methodology and a benchmark Black-Scholes implementation are now applied to S&P500 call options from Jun., 1, 1988 to May 31, 1991. First, the best LOR model is identified from the four structural and reduced-form specifications (1)-(4) described above. The gains from localization and an in-depth analysis of in-sample and out-of-sample pricing errors for the selected LOR model are then presented in relation to the PBS benchmark. Finally, the volatility smile effect in option prices generated by the LOR and PBS models is analyzed.

Out of the four candidate option regressions, the RLOR-V (reduced-form option regression with implied volatility) yields the lowest average pricing errors (RMSEs) upon localization to maturity-moneyness clusters and is, therefore, selected as the best LOR model for further analysis. It yields smaller average pricing errors ($0.5273 out-of-sample and $0.2467 in-sample) than the Black-Scholes benchmark ($0.6984 and $0.4782, respectively). In general LOR pricing appears more reliable and consistent across the whole spectrum of moneyness and maturity groupings.

LOR also compares favorably with more sophisticated models with stochastic volatility and jumps. Pricing errors are in the mid-point of ranges reported by other prior art approaches using the same three year sample of S&P500 options. Further, out-of-sample option prices generated by the LOR model are substantially free of the volatility smile/sneer effect while this effect is strongly present in PBS option prices.

The process begins by identifying the best LOR model among the volatility and no-volatility reduced-form and structural candidates: RLOR (1), SLOR (2), RLOR-V (3), and SLOR-V (4). In this example the in-sample and out-of-sample performance of these models is considered over a moving 50-day estimation window q of 22 periods spanning Jun. 1, 1988 to May 31, 1991. This leads to a total of 28,417 options for analyzing in-sample performance in the −10% to +10% moneyness range (m=S/K ∈[0.9,1.1]). The out-of-sample horizon is taken to be one day from the end of each rolling estimation period q. LOR out-of-sample option prices are generated using equations 10 through 14 and the corresponding PBS prices follow from equations 15 through 16.

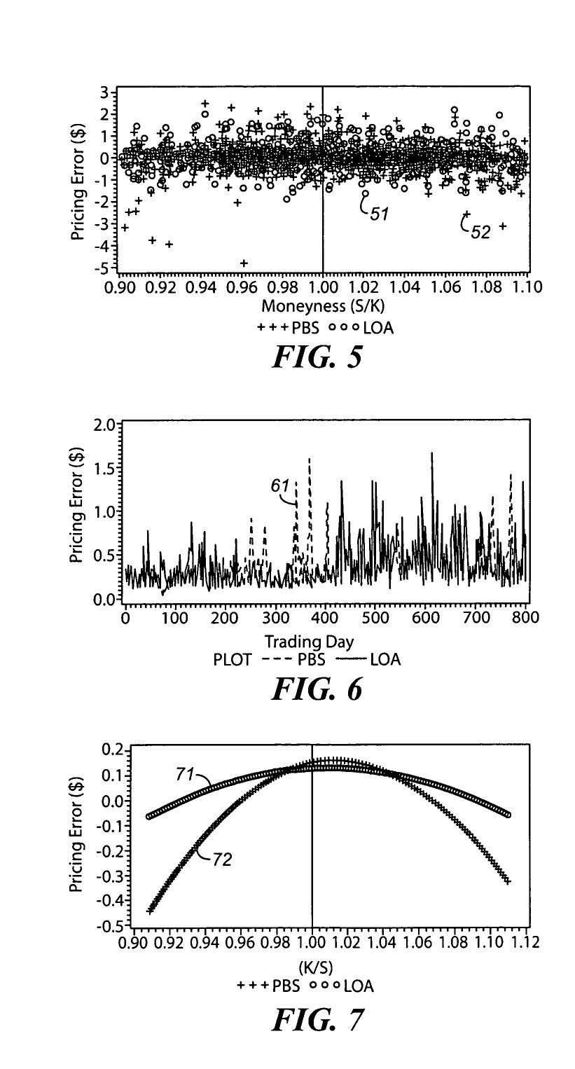

Out-of-sample pricing errors from both models are plotted by moneyness as depicted in FIG. 5. Circles 51 denote LOR moneyness and plus signs 52 denote PBS moneyness. FIG. 6 presents daily average pricing errors (i.e., RMSE) 61 for both models as based on out-of-sample predictions.

From the results reported in Table IV presented below, the reduced-form volatility model (RLOR-V) is identified as the best LOR candidate in this example, with its structural counterpart SLOR-V performing closely. RLOR-V yields in-sample and out-of-sample root mean square errors (RMSEs) of $0.2467 and $0.5273, respectively, while the same for the PBS model are $0.4782 and $0.6984, respectively. This amounts to a 32% reduction in out-of-sample pricing error for RLOR-V over the Black-Scholes implementation.

TABLE IV
Average Pricing Errors of LOR and PBS Models

| | | | Pricing Error | | | | Efficiency Gain | |
|---|---|---|---|---|---|---|---|---|
| | | | (PE or RMSE) | | | | (% EFF) | |
| Year | Mean | PBS | RLOR | SLOR | SLOR-V | RLOR-V | RLOR-V | SLOR-V |

Panel A: In-Sample Pricing Errors

| | | | | | | | | |
|---|---|---|---|---|---|---|---|---|
| All | $17.08 | $0.4782 | $0.4477 | $0.4493 | $0.2493 | $0.2467 | 48.40% | 47.87% |
| 1988 | 13.24 | 0.2825 | 0.3032 | 0.3042 | 0.1630 | 0.1609 | 43.06 | 42.30 |
| 1989 | 16.23 | 0.4841 | 0.3910 | 0.3922 | 0.2147 | 0.2127 | 56.06 | 55.64 |
| 1990 | 18.83 | 0.5019 | 0.5130 | 0.5146 | 0.2809 | 0.2782 | 44.58 | 44.03 |
| 1991 | 18.20 | 0.5522 | 0.4966 | 0.4990 | 0.2962 | 0.2928 | 46.97 | 46.35 |

Panel B: Out-of-Sample Pricing Errors

| All | $17.48 | $0.6984 | $0.5876 | $0.5860 | $0.5291 | $0.5273 | 32.44% | 31.98% |
|---|---|---|---|---|---|---|---|---|
| 1988 | 13.56 | 0.3087 | 0.4577 | 0.4551 | 0.3673 | 0.3669 | −15.86 | −15.96 |
| 1989 | 16.80 | 0.4881 | 0.4311 | 0.4325 | 0.4164 | 0.4128 | 18.25 | 17.23 |
| 1990 | 19.23 | 0.8715 | 0.6856 | 0.6845 | 0.6308 | 0.6303 | 38.28 | 38.15 |
| 1991 | 18.26 | 0.8253 | 0.6935 | 0.6875 | 0.5790 | 0.5750 | 43.53 | 42.53 |
| The in-sample and out-of-sample performance of localized option regression (LOR) models (1)-(4) and a benchmark ‘Practitioner Black-Scholes’ (PBS) model is reported over daily S&P500 call options from June 1988 to May 1991. LOR estimation is performed over moving 50-day windows by the maturity-moneyness clusters of Table III. The volatility estimates for both LOR and PBS models is based on predicted values from the DFW volatility regression (9) where implied volatility is regressed | | | | | | | | |
| # on linear and quadratic terms of option maturity and exercise price. For out-of-sample results, LOR and volatility regression parameters from the previous day are used to generate option prices over the next day using (10)-(14); PBS out-of-sample option prices are obtained using the Black-Scholes formula (15)-(16). The average pricing error ($PE) is the RMSE based on the difference between the option's market price and the model price. The efficiency gain (EFF) is the relative | | | | | | | | |
| # percentage reduct average pricing error achieved by LOR over Black-Scholes. | | | | | | | | |

Implied volatility in the localized option regressions can have a significant impact. With implied volatility as an additional covariate in LOR, out-of-sample performance falls by around 8 cents to $0.5876 and $0.5860 (from $0.5273) for RLOR and SLOR, respectively. Based on the comparative analysis of the four LOR specifications, one can select RLOR-V as the best localized option regression model for the remaining analysis. Hereafter for the example this model shall simply be referred to as “LOR”.

It is known to evaluate the performance of alternative option pricing models incorporating stochastic volatility (SV), stochastic volatility & stochastic interest rates (SVSI), and stochastic volatility with jumps (SVJ) and to compare these models with Black-Scholes (BS) results. In such an analysis, model parameters and implied volatility are typically estimated from previous-day option prices and are used to generate next-day prices.

Such an approach does not report overall pricing errors, but tabulates pricing errors by combinations of, for example, 18 maturity-moneyness categories. Here, ranges of pricing errors over these combination are: $0.52-1.89 for BS, $0.41-0.65 for SV, $0.37-0.57 for SVSI and $0.37-0.59 for SVJ. These results show that such an implementation of Black-Scholes is dominated by the stochastic volatility and jump models and the performance of the SV, SVSI, and SVJ models is similar.

The results noted above with respect to Table IV show that the overall out-of-sample pricing error of the selected LOR model ($0.5273) is in the mid-point of the ranges of better performing models such as SV, SVSI, and SVJ models analyzed using the same sample by other benchmark prior art approaches. Taken in concert with an appropriate Black-Scholes benchmark, this comparison provides further evidence that LOR modeling is competitive with a Black-Scholes implementation, as well as more sophisticated extensions that employ stochastic volatility and jumps in the return process.

The gains from localization and the in-sample performance of LOR and PBS will now be considered in greater detail. Tables V and VI shown below show tabulations of pricing errors by year-quarter and maturity-moneyness groups.

TABLE V
In-Sample Performance of LOR & PBS Models

| | | | LOR | PBS | EFF | Call | CV |
|---|---|---|---|---|---|---|---|
| Year | Quarter | # Calls | ($PE) | ($PE) | (%) | Mean | (%) |
| All | All | 28,417 | $0.2467 | $0.4782 | 48.40% | $17.08 | 2.80 |
| 1988 | All | 4,268 | 0.1609 | 0.2825 | 43.06 | 13.24 | 2.13 |
| 1989 | All | 8,875 | 0.2127 | 0.4841 | 56.06 | 16.23 | 2.98 |
| 1990 | All | 10,939 | 0.2782 | 0.5019 | 44.58 | 18.83 | 2.67 |
| 1991 | All | 4,335 | 0.2928 | 0.5522 | 46.97 | 18.20 | 3.03 |
| 1988 | 3 | 2,275 | 0.1549 | 0.2379 | 34.9 | 12.44 | 1.91 |
| 1988 | 4 | 1,993 | 0.1674 | 0.3260 | 48.6 | 14.16 | 2.30 |
| 1989 | 1 | 2,058 | 0.1621 | 0.4132 | 60.8 | 14.26 | 2.90 |
| 1989 | 2 | 2,056 | 0.1765 | 0.4800 | 63.2 | 15.72 | 3.05 |
| 1989 | 3 | 2,368 | 0.2200 | 0.5281 | 58.3 | 17.24 | 3.06 |
| 1989 | 4 | 2,393 | 0.2656 | 0.4984 | 46.7 | 17.35 | 2.87 |
| 1990 | 1 | 2,719 | 0.3251 | 0.5158 | 37.0 | 18.68 | 2.76 |
| 1990 | 2 | 2,921 | 0.2413 | 0.4855 | 50.3 | 20.14 | 2.41 |
| 1990 | 3 | 2,646 | 0.2640 | 0.4850 | 45.6 | 18.04 | 2.69 |
| 1990 | 4 | 2,653 | 0.2777 | 0.5214 | 46.7 | 18.32 | 2.85 |
| 1991 | 1 | 2,439 | 0.3112 | 0.5748 | 45.9 | 18.04 | 3.19 |
| 1991 | 2 | 1,896 | 0.2674 | 0.5216 | 48.7 | 18.40 | 2.84 |
| The in-sample pricing performance by quarter and year is reported for the selected localized option regression model (3, RLOR-V) model and the benchmark ‘Practitioner Black-Scholes’ (PBS) over daily S&P500 call options from June 1988 to May 1991. LOR estimation is performed over moving 50-day windows by the maturity-moneyness clusters of Table III. The volatility estimates for both LOR and PBS models are based on predicted values from the DFW volatility regression (9) where daily implied | | | | | | | |
| # volatilities are regressed on linear and quadratic terms of option maturity and exercise price. The average pricing error ($PE) is the RMSE based on the difference between the option's market price and the model price. The efficiency gain (EFF) is the relative percentage reduction in average pricing error achieved by LOR over Black-Scholes. The correlation of variation (CV) is the percentage pricing error relative to the mean option value ($PE/Call Mean). | | | | | | | |

TABLE VI
In-Sample Performance by Maturity-Moneyness Groups

| Maturity | Money-ness | LOR | PBS | EFF | Call | CV |
|---|---|---|---|---|---|---|
| (Days) | (m = S/K) | ($PE) | ($PE) | (%) | Mean | (%) |
| All | All | $0.2467 | $0.4782 | 48.40% | $17.08 | 2.80 |
| Less than 50 | [0.9, 0.95] | 0.1725 | 0.2015 | 14.4 | 1.52 | 13.26 |
| | (0.95, 1.0] | 0.2194 | 0.3015 | 27.2 | 3.84 | 7.86 |
| | (1.0, 1.05] | 0.2007 | 0.3177 | 36.8 | 12.75 | 2.49 |
| | (1.05, 1.1] | 0.1820 | 0.3672 | 50.5 | 25.29 | 1.45 |
| 50 to 100 | [0.9, 0.95] | 0.1521 | 0.2481 | 38.7 | 3.13 | 7.94 |
| | (0.95, 1.0] | 0.1606 | 0.2925 | 45.1 | 8.17 | 3.58 |
| | (1.0, 1.05] | 0.1646 | 0.2973 | 44.6 | 18.28 | 1.63 |
| | (1.05, 1.1] | 0.1658 | 0.4416 | 62.5 | 30.49 | 1.45 |
| More than | [0.9, 0.95] | 0.3335 | 0.8003 | 58.3 | 10.58 | 7.57 |
| 100 | (0.95, 1.0] | 0.3151 | 0.5931 | 46.9 | 18.40 | 3.22 |
| | (1.0, 1.05] | 0.2812 | 0.4668 | 39.8 | 28.68 | 1.63 |
| | (1.05, 1.1] | 0.2733 | 0.5343 | 48.8 | 39.19 | 1.36 |
| Pricing performance by maturity and moneyness categories is reported for the selected localized option regression model (3, RLOR-V) model and the benchmark ‘Practitioner Black-Scholes’ (PBS) model over daily S&P500 call options from June 1988 to May 1991. LOR estimation is performed over moving 50-day windows by the maturity-moneyness clusters of Table III. The volatility estimates for both LOR and PBS models are based on predicted values from the DFW volatility regression (9) | | | | | | |
| # where daily implied volatilities is regressed on linear and quadratic terms of option maturity and exercise price. The average pricing error ($PE) is the RMSE based on the difference between the option's market price and the model price. The efficiency gain (EFF) is the relative percentage reduction in average pricing error achieved by LOR over Black-Scholes. The correlation of variation (CV) is the percentage pricing error relative to the mean option value ($PE/Call Mean). | | | | | | |

One can note a dramatic increase in performance over the previously ascertained global fit: the overall pricing error shrinks to $0.2467 (RLOR-V) from $1.2985 (RLOR-V, Table II). Second, the overall reduction in pricing error (efficiency gain) of LOR over PBS is 48.4% (EFF). Further, LOR pricing errors disaggregated by year and quarter fall in the range $0.1549-$0.3251, representing gains in pricing efficiency of 34.9%-63.2% over PBS. Third, the coefficient of variation (CV) gives the pricing error as a percentage of mean call price. These are relatively small, falling in the range 1.91%-3.19%.

Table VI gives tabulation of pricing errors and efficiency gain by maturity-moneyness categories. The pricing errors for LOR over the 12 categories fall in the range of $16.06-$33.35 and correspond with efficiency gains of 14.4%-62.5% over the Black-Scholes benchmark. The performance of LOR over option moneyness is more consistent and stable as pricing errors are similar in magnitude over the four moneyness (S/X) ranges from 0.9 to 1.1. For example, among the shortest maturity calls (less than 50 days), the pricing errors are $0.1725, $0.2194, $0.2007 and $0.1820, respectively, over the moneyness categories [0.9,0.95], (0.95,1.0], (1,1.05], (1.05,1.1] while PBS errors over the same categories are $0.2012, $0.3015, $0.3177 and $0.3672.

Such in-sample empirical results demonstrate the superior performance of localized option regression modeling over the Black-Scholes benchmark in terms of pricing precision and stability of estimates. Out-of-sample performance will now be considered in greater detail.

LOR model parameters are estimated in this example using a moving 50-day window from Jun. 1, 1988 to May 31, 1991 and are used to construct predictions of option prices over the subsequent trading day. This generates 22 sequential estimation cycles and estimation is localized within each cycle to the maturity-moneyness clusters defined in Table III. In this example, this procedure leads to 763 out-of-sample option prices with the results being substantially similar regardless of the starting point (other starting dates in June 1988, aside from June 1, were also tried and yield similar results). Daily PBS out-of-sample option prices are constructed from equations 15 through 16.

Again LOR outperforms the PBS benchmark. Tables VII and VIII presented below show tabulations of pricing errors by year-quarter, estimation cycle, and maturity-moneyness groupings.

TABLE VII
Out-of-Sample Performance of LOR and PBS Models

| | Cycle | LOR | PBS | EFF | Call | CV |
|---|---|---|---|---|---|---|
| Year | (q) | ($PE) | ($PE) | (%) | Mean | (%) |
| All | All | $0.5273 | $0.6984 | 32.44% | $17.48 | 3.99% |
| 1988 | All | 0.3669 | 0.3087 | −15.86 | 13.56 | 2.28 |
| 1989 | All | 0.4128 | 0.4881 | 18.25 | 16.8 | 2.91 |
| 1990 | All | 0.6303 | 0.8715 | 38.28 | 19.23 | 4.53 |
| 1991 | All | 0.5750 | 0.8253 | 43.53 | 18.26 | 4.52 |
| | 2 | 0.2318 | 0.2419 | 4.36 | 12.20 | 1.98 |
| | 3 | 0.1793 | 0.1933 | 7.78 | 13.16 | 1.47 |
| | 4 | 0.6234 | 0.4425 | −29.02 | 13.71 | 3.23 |
| | 5 | 0.2138 | 0.2688 | 25.71 | 14.56 | 1.85 |
| | 6 | 0.3234 | 0.3750 | 15.97 | 16.71 | 2.24 |
| | 7 | 0.2466 | 0.2659 | 7.79 | 13.02 | 2.04 |
| | 8 | 0.3245 | 0.5211 | 60.58 | 15.11 | 3.45 |
| | 9 | 0.2339 | 0.3431 | 46.70 | 19.63 | 1.75 |
| | 10 | 0.7635 | 0.3395 | −55.53 | 17.31 | 1.96 |
| | 11 | 0.4881 | 0.3680 | −24.60 | 16.77 | 2.20 |
| | 12 | 0.3421 | 0.8102 | 136.86 | 18.29 | 4.43 |
| | 13 | 0.8655 | 1.2822 | 48.14 | 18.81 | 6.82 |
| | 14 | 0.6305 | 0.4346 | −31.07 | 17.91 | 2.43 |
| | 15 | 0.4546 | 0.5677 | 24.86 | 19.87 | 2.86 |
| | 16 | 0.3275 | 1.3635 | 316.31 | 21.16 | 6.44 |
| | 17 | 0.7175 | 0.7728 | 7.70 | 18.44 | 4.19 |
| | 18 | 0.7267 | 0.6455 | −11.18 | 19.26 | 3.35 |
| | 19 | 0.5904 | 0.9682 | 63.98 | 19.71 | 4.91 |
| | 20 | 0.9542 | 1.4090 | 47.66 | 21.37 | 6.59 |
| | 21 | 0.3215 | 0.2532 | −21.25 | 14.82 | 1.71 |
| | 22 | 0.2028 | 0.4163 | 105.28 | 19.69 | 2.11 |
| The out-of-sample pricing performance is reported for the best LOR model (3, RLOR-V) model and the benchmark ‘Practitioner Black-Scholes’ (PBS) model over the sample of S&P500 call options from June 1988 to May 1991. LOR estimation is performed over a moving 50-day window by the maturity-moneyness clusters of Table III. The volatility estimates for both LOR and PBS models are based on predicted values from the volatility regression represented by equation 9 where daily implied volatilities are | | | | | | |
| # regressed on linear and quadratic terms of option maturity and exercise price. The estimated LOR and volatility parameters are then used to generate LOR option prices over the next day using (10)-(14); PBS out-of-sample option prices are generated under the Black-Scholes formula (15)-(16). The average pricing error ($PE) is the RMSE based on the difference between the option's market price and the model price. The efficiency gain (EFF) is the relative percentage reduction in average pricing | | | | | | |
| # error relative to correlation of variation (CV) is the percentage pricing error relative to the mean option value ($PE/Call Mean). | | | | | | |

TABLE VIII
Out-of-Sample Performance over Maturity-Moneyness Groups

| Maturity | Money-ness | LOR | PBS | EFF | Call | CV |
|---|---|---|---|---|---|---|
| (Days) | (m = S/K) | ($PE) | ($PE) | (%) | Mean | (%) |
| All | All | $0.5273 | $0.6984 | 32.44% | $17.48 | 3.99% |
| Less than | [0.9, 0.95] | 0.3292 | 0.3443 | 4.57 | 1.65 | 20.85 |
| 50 | (0.95, 1.0] | 0.4372 | 0.4419 | 1.06 | 4.00 | 11.05 |
| | (1.0, 1.05] | 0.4930 | 0.4705 | −4.56 | 13.22 | 3.56 |
| | (1.05, 1.1] | 0.4934 | 0.5693 | 15.38 | 25.64 | 2.22 |
| 50 to 100 | [0.9, 0.95] | 0.3317 | 0.4648 | 40.15 | 3.25 | 14.32 |
| | (0.95, 1.0] | 0.5607 | 0.6523 | 16.34 | 8.04 | 8.11 |
| | (1.0, 1.05] | 0.4800 | 0.6275 | 30.71 | 18.58 | 3.38 |
| | (1.05, 1.1] | 0.5070 | 0.6383 | 25.90 | 30.50 | 2.09 |
| More than | [0.9, 0.95] | 0.5818 | 0.9622 | 65.39 | 10.46 | 9.19 |
| 100 | (0.95, 1.0] | 0.5468 | 0.8930 | 63.32 | 18.79 | 4.75 |
| | (1.0, 1.05] | 0.5109 | 0.6518 | 27.57 | 28.80 | 2.26 |
| | (1.05, 1.1] | 0.7246 | 0.8767 | 20.99 | 38.92 | 2.25 |
| Pricing performance by maturity and moneyness categories is reported for the best LOR model (3, RLOR-V) model and the benchmark ‘Practitioner Black-Scholes’ (PBS) model over the sample of S&P500 call options from June 1988 to May 1991. LOR estimation is performed over a moving 50-day window by the maturity-moneyness clusters of Table III. The volatility estimates for both LOR and PBS models are based on predicted values from the volatility | | | | | | |
| # regression represented by equation 9 where daily implied volatilities are regressed on linear and quadratic terms of option maturity and exercise price. The estimated LOR and volatility parameters are then used to generate LOR option prices over the next day using (10)-(14); PBS out-of-sample option prices are generated under the Black-Scholes formula (15)-(16). The average pricing error ($PE) is the RMSE based on the difference between the option's | | | | | | |
| # market price and the model price. The efficiency gain (EFF) is the relative percentage reduction in average pricing error achieved by LOR over Black-Scholes. The correlation of variation (CV) is the percentage pricing error relative to the mean option value ($PECall Mean). | | | | | | |

The overall average pricing errors for LOR and PBS are $0.5273 and $0.6984, respectively, and LOR pricing error as a percentage of the mean option price (CV) is 3.99%. The efficiency gain of LOR over PBS across all 21 out-of-sample periods is 32.4% and LOR dominated PBS in 15 of these periods (see Table VII).

With respect to tabulation across maturity-moneyness categories (Table VIII), it can be seen that LOR dominates PBS in 11 of the 12 combinations. The LOR pricing errors fall in the range $0.3292-$0.7296 and the same for PBS is $0.3443-$0.9622.

Overall, such results demonstrate that local option regression (LOR) modeling provides smaller out-of-sample pricing errors than a Black-Scholes implementation. The consistency and reliability of the in-sample and out-of-sample results provides confidence in the use of LOR as an option valuation tool and as a robust and efficient benchmark for evaluating other structural option pricing models.

An important empirical deficiency of the Black-Scholes model is the occurrence of the so-called volatility smile (or smirk) where the option's implied volatility depends on the value of the strike price, usually in a “smile” or “sneer” pattern. One way to examine the volatility smile issue is to compute the implied volatility of option prices across strikes by inverting the Black-Scholes formula. Given the positive monotonic relationship between volatility and option value, the smile effect in LOR and PBS option prices may also be alternatively, and directly, analyzed in the price-strike space. This analysis can be performed by testing for the following functional relationship between pricing errors and the option's moneyness (K/S) in the price-smile regression

Vᵢ−Vᵢ^{Model}=β₀+β₁(K/S)+β₂(K/S)²εᵢ (19)

where Vᵢ−Vᵢ^{Model} is the pricing error under the respective model (LOR or PBS). The price-smile regression (19) is analogous to a paired t-test as the price difference Vᵢ−Vᵢ^{Model} cancels all factors effecting option valuation (strike, maturity, index value, discount rate) with the exception of volatility and the regression tests for the residual's dependence on strike. Further, the monotonic relationship between option price and volatility ensures that the smile effect is uniquely captured by the price-smile regression (19).

The results from the volatility smile analysis of LOR and BS models are reported in Table IX shown below and the fitted regression values are as follows:

PBS: Vᵢ−Vᵢ^{Model}=−55.81+110.31(K/S)−54.35(K/S)² (20)

LOR: Vᵢ−Vᵢ^{Model}=−9.02+17.85(K/S)−8.78(K/S)² (21)

TABLE IX
LOR & PBS Volatility Smile Effects

| | | | Standard | | |
|---|---|---|---|---|---|
| Model | Variable | Estimate | Error | t-value | p-value |
| PBS | Intercept | −55.8092 | 9.1909 | −6.07 | <.0001 |
| | K/S | 110.3114 | 18.3272 | 6.02 | <.0001 |
| | (K/S)² | −54.3526 | 9.1183 | −5.96 | <.0001 |
| LOR | Intercept | −9.0174 | 7.1079 | −1.27 | 0.2050 |
| | K/S | 17.8450 | 14.1737 | 1.26 | 0.2084 |
| | (K/S)² | −8.7806 | 7.0518 | −1.25 | 0.2135 |
| The volatility smile effect for LOR and PBS out-of-sample prices is estimated using the price-smile regression (19). Option pricing errors Vᵢ − Vᵢ^{Model} (difference between market and model prices) are regressed on linear and quadratic terms of K/S (strike over price). The regression is analogous to a paired t-test as the price difference Vᵢ − Vᵢ^{Model} cancels all factors effecting option valuation (strike, maturity, index, discount | | | | | |
| # rate) with the exception of volatility, and the residual difference is tested for dependence on strike. The monotonic relationship between option price and volatility ensures that the smile effect is uniquely captured by the price difference Vᵢ − Vᵢ^{Model}. The volatility smile is absent if both the linear and quadratic terms of the price-smile regression are not significant. The results show a very strong smile effect in PBS option prices while the same effect | | | | | |
| # is weak and statistically insignificant in LOR option prices. | | | | | |

The estimates reveal a very strong smile/sneer effect in PBS option prices. The effect is substantially non-existent in LOR prices. The linear and quadratic smile parameters (β₁ and β₂, respectively) in the PBS price-smile regression are large and very strongly significant with significance probabilities less than 0.0001. For LOR, the same parameters are much smaller in magnitude and are not statistically significant.

Predicted values based on the LOR and PBS price-smile regressions (equations 20 and 21) are plotted in FIG. 7. The relatively flat curve 71 for LOR again points to the negligible volatility smile effect in LOR option prices in contrast to the curve 72 that corresponds to PBS prices.

Results from this empirical analysis show that not only do option prices from the selected localized option regression modeling provide smaller pricing errors than the Practitioner Black-Scholes approach (both in-sample and out-of-sample), but LOR prices are considerably more free of the volatility smile effect.

The Black-Scholes option pricing model and its various extensions are essentially based on the principle that if the price risk of the derivative security can be dynamically hedged by trading in the underlying asset, then risk-neutral no-arbitrage arguments can be applied to determine its equilibrium market price. How well risk-neutral theory and option models are able to explain actual market option prices depends on the extent to which the assumptions and mechanics behind the risk-neutral models and arbitrage arguments hold in actual markets (e.g. frictionless hedging, log-normality of asset prices, diffusive stochastic volatility, and so forth). Furthermore, the wide choice in available models and assumptions, along with estimation error in key parameters, implies that the relationship between prices from theoretical option models and observed market prices is necessarily approximate.

These teachings propose an econometric approach to modeling and estimating market option prices based on localized option regression (LOR) modeling where option prices can be projected, for example, over localized regions of their state process up to maturity. These embodiments make a number of contributions with respect to pricing accuracy, robustness, and the volatility smile effect in option prices.

First, the above described empirical analysis using S&P500 options (and comparison with prior art teachings) shows that LOR offers a reliable and robust data-driven approach to modeling and estimating market option prices that is competitive with structural risk-neutral option models such as the Black-Scholes and other extensions with stochastic volatility and jumps in the return process. For example, LOR provides smaller average pricing errors ($0.5273 out-of-sample and $0.2467 in-sample) than an efficient Black-Scholes benchmark used in many empirical studies and compares favorably with other stochastic volatility and jump models using the same sample of S&P500 options.

Second, LOR is robust to assumptions on the asset price dynamics required in risk-neutral option models. This is due at least in part to structural and distributional assumptions on the asset price process such as log-normality, Geometric Brownian motion, and diffusive stochastic volatility that are not utilized by the LOR framework. Third, the volatility smile effect in virtually non-existent in LOR S&P500 option prices while the same persists strongly in the Black-Scholes implementation (PBS).

Lastly, in addition to being a competitive option valuation and verification tool, these LOR models provide a reliable, easy to implement, and robust econometric benchmark for evaluating the performance and contribution of more complex structural risk-neutral models.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. A method for valuing options comprising:
selecting an option;
providing empirical data that corresponds to the option;
processing the empirical data using regression modeling to provide an option valuation model for the option;
using the option valuation model to value the option with respect to future worth.

2. The method of claim 1 wherein selecting an option further comprises selecting at least one of:
an index option;
an interest rate option;
a currency option;
a bond option;
a stock option;
a commodity option:
a futures contract:
a forward contract.

3. The method of claim 1 wherein providing empirical data that corresponds to the option further comprises providing empirical data for a substantially immediately preceding window of time.

4. The method of claim 1 wherein providing empirical data that corresponds to the option further comprises providing empirical data for a preceding window of time having at least a predetermined duration.

5. The method of claim 4 wherein providing empirical data for a preceding window of time having at least a predetermined duration further comprises providing empirical data for a preceding window of time comprising at least fifty days.

6. The method of claim 1 wherein providing empirical data that corresponds to the option further comprises providing pricing information that corresponds to the option.

7. The method of claim 6 wherein providing pricing information that corresponds to the option further comprises providing daily closing prices for a plurality of days as corresponds to the option.

8. The method of claim 1 wherein processing the empirical data using regression models to provide an option valuation model for the option further comprises projecting market option prices over localized regions of the option's state process.

9. The method of claim 8 wherein projecting market option prices over localized regions of the option's state process further comprises projecting market option prices over localized regions of the option's state process up to projected maturity of the option.

10. The method of claim 1 wherein processing the empirical data using regression modeling to provide an option valuation model for the option further comprises providing a structural option valuation model that models the option's non-linear behavior around a corresponding strike price.

11. The method of claim 10 wherein providing a structural option valuation model that models the option's non-linear behavior around a corresponding strike price further comprises providing a structural option valuation model that models the option's non-linear behavior around a corresponding strike price by use of a moneyness variable.

12. The method of claim 1 wherein processing the empirical data using regression modeling to provide an option valuation model for the option further comprises providing a reduced-form option valuation model.

13. The method of claim 1 wherein processing the empirical data using regression modeling to provide an option valuation model for the option further comprises projecting market options onto a quadratic state-space of corresponding state variables that characterize the option.

14. The method of claim 13 wherein processing the empirical data using regression modeling to provide an option valuation model for the option yet further comprises taking into account implied volatility of the option.

15. The method of claim 1 wherein using the option valuation model to value the option with respect to future worth further comprises localizing estimation of option regressions to subregions of overall state space as corresponds to the option.

16. The method of claim 15 wherein localizing estimation of option regressions to subregions of overall state space as corresponds to the option further comprises sequentially estimating option regressions as a function, at least in part, of maturity-moneyness clusters over a rolling estimation window.

17. The method of claim 1 wherein processing the empirical data using regression data to provide an option valuation model for the option further comprises providing a plurality of different option valuation models.

18. The method of claim 17 wherein providing a plurality of different option valuation models further comprises:
developing resultant data using the plurality of different option valuation models;
comparing the resultant data with historical data for the option;
selecting a particular one of the plurality of different option valuation models as based, at least in part, on comparing the resultant data with historical data for the option to provide a selected option valuation model.

19. The method of claim 18 wherein using the option valuation model to value the option with respect to future worth further comprises using the selected option valuation model to value the option with respect to future worth.

20. A digital memory having stored therein instructions that correspond, at least in part, to:
empirical data that corresponds to an option;
an option valuation model derived as a function, at least in part, of processing the empirical data using regression modeling.

21. The digital memory of claim 20 wherein the option comprises at least one of:
an index option;
an interest rate option;
a currency option;
a bond option;
a stock option;
a commodity option;
a futures contract;
a forward contract.

22. The digital memory of claim 20 wherein the option valuation model further comprises an option valuation model that is derived as a function, at least in part, of projecting market option prices over localized regions of state processes of the option.

23. The digital memory of claim 22 wherein the option valuation model further comprises an option valuation model that is derived as a function, at least in part, of projecting market option prices over localized regions of state processes of the option up to projected maturity of the option.
